(19) United States
(12) Patent Application Publication
(10) Pub. No.: US 2021/0293410 A1
(43) Pub. Date: Sep. 23, 2021

(54) Emissions Eliminator by Total Combustion

(71) Applicant: Total Combustion, LLC, Palm Beach Gardens, FL (US)

(72) Inventors: Harold Glasband, West Palm Beach, FL (US); James W. Moore, Mogadore, OH (US); Jacob M. Youngman, Palm Beach Gardens, FL (US); Anthony R. Trianfante, Aurora, OH (US)

(73) Assignee: Total Combustion, LLC, Palm Beach Gardens, FL (US)

(21) Appl. No.: 17/341,217

(22) Filed: Jun. 7, 2021

Related U.S. Application Data
(63) Continuation of application No. 17/085,303, filed on Oct. 30, 2020.
(60) Provisional application No. 62/928,489, filed on Oct. 31, 2019.

(51) Int. Cl. F23G 7/08; F23D 14/32; F23K 5/00; F23N 5/24; F23N 1/00; F23N 5/00; F23G 5/50

(52) U.S. Cl. CPC F23G 7/085; F23D 14/32; F23K 5/007; F23N 5/245; F23N 1/005; F23N 2241/18; F23G 5/50; F23N 2235/16; F23D 2203/007; F23G 2207/10; F23K 2900/05004; F23N 5/003

(57) ABSTRACT

An innovative oxyhydrogen (HHO) burner system including one or more burner systems is provided to eliminate emissions through total combustion. Each burner system includes at least one HHO gas supply and an external natural gas supply, both of which are connected to a gas mixer. A controller regulates the amounts of incoming HHO gas and the natural gas through being mixed. The mixed gas is supplied to each burner assembly with a predetermined pressure and flowrate to generate a flame for the total combustion of the exhaust stream inside the exhaust pipe. With feedback from an exhaust measuring system inside the exhaust pipe adjacent the outlet, the controller can adjust the burner system for optimal operations and achieve total combustion. Thus, by passing the exhaust or gases through a substantial cross-section covered by each flame, emissions can be greatly reduced or eliminated.

### CROSS-REFERENCE TO RELATED APPLICATIONS

The current application claims priority to U.S. patent application Ser. No. 17/085,303 filed on Oct. 30, 2021, which claims priority to U.S. Provisional Patent Application No. 62/928,489 filed on Oct. 31, 2019, both of which are fully incorporated by reference.

### FIELD OF THE INVENTION

The present invention relates generally to emissions control equipment. More specifically, the present invention relates to an oxyhydrogen and natural gas burner system that can efficiently and conveniently be attached to new and existing exhaust stack and equipment to reduce or eliminate harmful emissions through total combustion.

### BACKGROUND OF THE INVENTION

Devices for reducing or eliminating dangerous emissions from emission-generating systems are in high demand. Heavy oil extracted using existing techniques is known to produce significant emissions including CO2, SOx, NOx, and particulate matter, etc. The use of natural gas, which produces lower levels of CO2, NOx, and SOx emissions per unit of energy than any other fossil fuel except pure hydrogen, does not require expensive boilers, or reduction equipment for NOx reduction, flue gas desulfurization, and/or particulate matter emissions. Although natural gas is a highly effective fuel source, it is also, in many instances, a nonideal and expensive method for simply raising heat. The use of alternative “dirty” fuels requires use of emission reduction equipment such as selective catalytic reduction and selective noncatalytic reduction of NOx, flue gas desulfurization to remove SOx, and electrostatic precipitation or filtration of particulate matter.

Many types of combustion equipment, including conventional steam generators and boilers, inherently produce substantial amounts of combustion or “stack gases” owing to the nature of the combustion process employed. Thus, the products of the combustion cannot be prevented from entering the atmosphere when using these types of combustion equipment. The highly undesirable environmental impact of any such large-scale combustion has limited the use of surface steam generation by boilers in many areas where atmospheric pollution has reached critical levels.

Conventional surface steam generators, particularly when fired using low-cost fuels, emit substantial amounts of objectionable combustion gases. Such side effect limits the use of fuels such as residual oil, leased crude oil, and other carbonaceous fuels. Furthermore, much currently available combustion equipment requires that the combustion process be essentially “clean.”

Accordingly, there is a need for devices with which to effectively remove or reduce undesirable material attendant in the combustion process. The present invention is intended to solve the problems associated with the creation of objectionable combustion gases through an innovative configuration for a device designed to eliminate emissions.

### SUMMARY OF THE INVENTION

An innovative oxyhydrogen (HHO) burner system including one or more hydroburner is offered to eliminate emissions through total combustion. The HHO burner system can be added to any exhaust system and/or exhaust stack to reduce emissions by passing the exhaust and/or gases through the flames and heat created by the hydroburner to create a total combustion environment. The HHO burner system works by adding one or more custom-made hydroburner system to any stack, duct, or pipe, and delivering to the burner natural gas, propane, or any other fossil fuel gas and any type of water gas, such as HHO or Brown's gas, with or without compressed air, to create a total combustion of the exhaust before being released to the open environment.

Each hydroburner system uses a gas pipe to connect a hydroburner to a burner assembly, which provides a controlled flame to a cross-section of the exhaust pipe where an exhaust stream with emissions passes through. The hydroburner system includes at least one HHO gas supply and an external natural gas supply, both of which are controlled by a controller that regulates the ratio of amount of the incoming HHO gas to the natural gas. The at least one HHO gas supply is connected to a gas mixer through a spark arrestor which is also controlled by the controller to provide safety shutdown of the hydroburner system in the case a flash back occurs to the at least one HHO gas supply. The external natural gas supply is connected to an actuator through a series of check valves and safety valves. The actuator is controlled by the controlled and connected to the gas mixer, where the predetermined amount of incoming HHO gas and external natural gas are mixed. The mixed gas is supplied to each burner assembly through a metering device and limiting valve, both of which are controlled by the controller to achieve a predetermined pressure and flowrate of the mixed gas being used to generate the flame for the total combustion of the exhaust stream inside the exhaust pipe. Thus, by passing all exhaust or gases through a substantial cross-section covered by each flame, emissions can be greatly reduced or even, in many cases, eliminated, including emissions of NOx, carbon, and sulfur dioxide, etc.

Further, the HHO burner system uses a plurality of sensors to detect the emission content of the exhaust stream before exiting the exhaust pipe. The plurality of sensors is positioned inside the exhaust pipe adjacent the outlet and connected to a measurement system, which sends measured data to the controller. By making adjustments of the hydroburner through the controller, the HHO burner system can achieve total combustion and elimination of emissions from the exhaust. Additionally, the HHO burner system provides efficient and convenient installation to any new and existing exhaust stack, pipe, and/or duct to ensure minimum system downtime and achieve the highest efficiency with the lowest costs.

### BRIEF DESCRIPTION OF THE DRAWINGS

FIG. 1 is a system diagram of the present invention.

FIG. 2 is a diagram of a hydroburner system of the present invention.

FIG. 3 is a top view of an embodiment of the hydroburner system of the present invention.

FIG. 4 is a front view of an embodiment of the hydroburner system of the present invention.

FIG. 5 is a back view of an embodiment of the hydroburner system of the present invention.

FIG. 6 is a left view of an embodiment of the hydroburner system of the present invention.

FIG. 7 is a right view of an embodiment of the hydroburner system of the present invention.

FIG. 8 is a front view of a gas mixer of the hydroburner system of the present invention.

FIG. 9 is a top view of a gas mixer of the hydroburner system of the present invention.

FIG. 10 is an electrical diagram of the hydroburner system of the present invention.

### DETAIL DESCRIPTIONS OF THE INVENTION

All illustrations of the drawings are for the purpose of describing selected versions of the present invention and are not intended to limit the scope of the present invention.

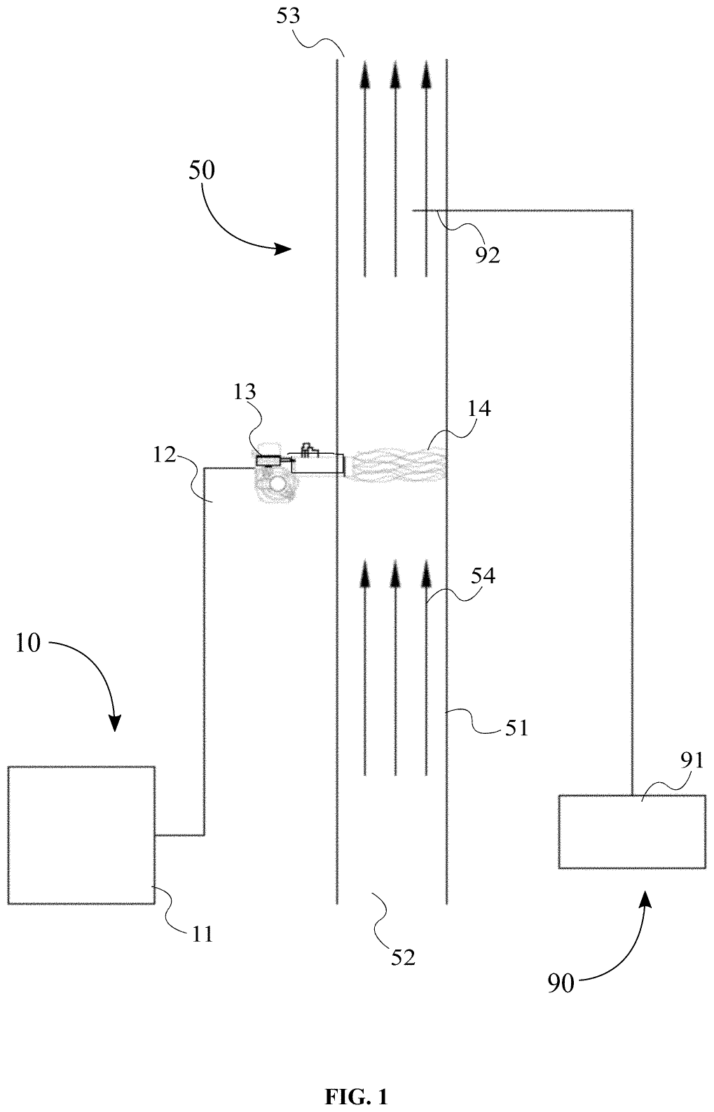

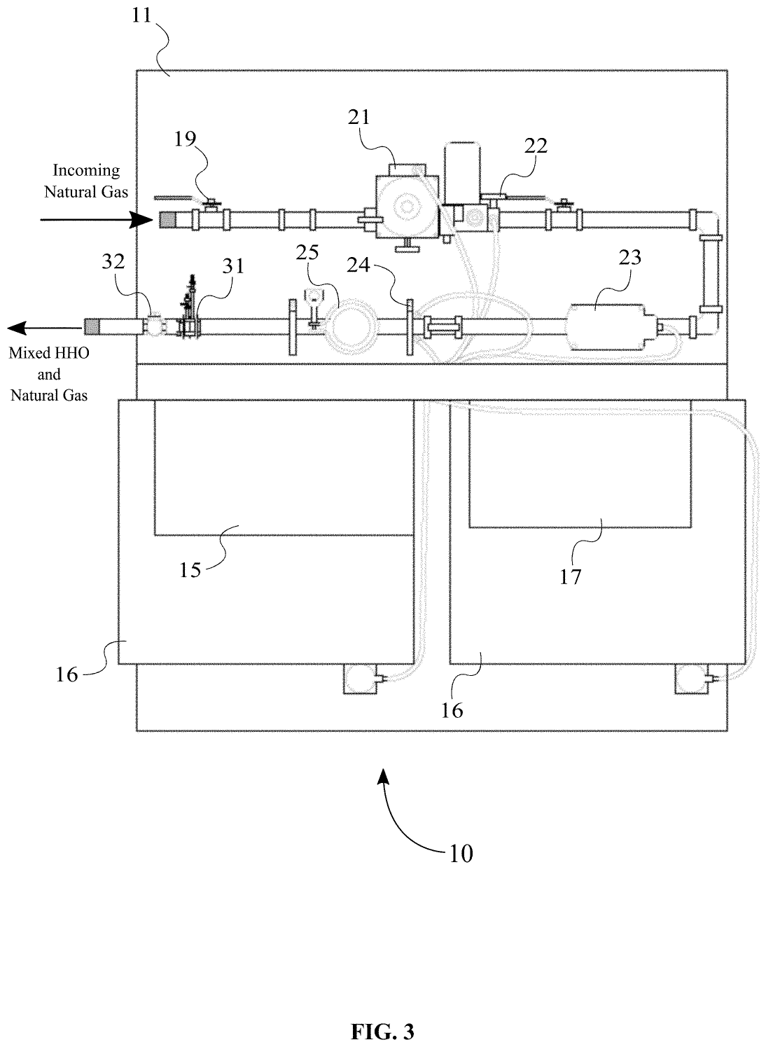

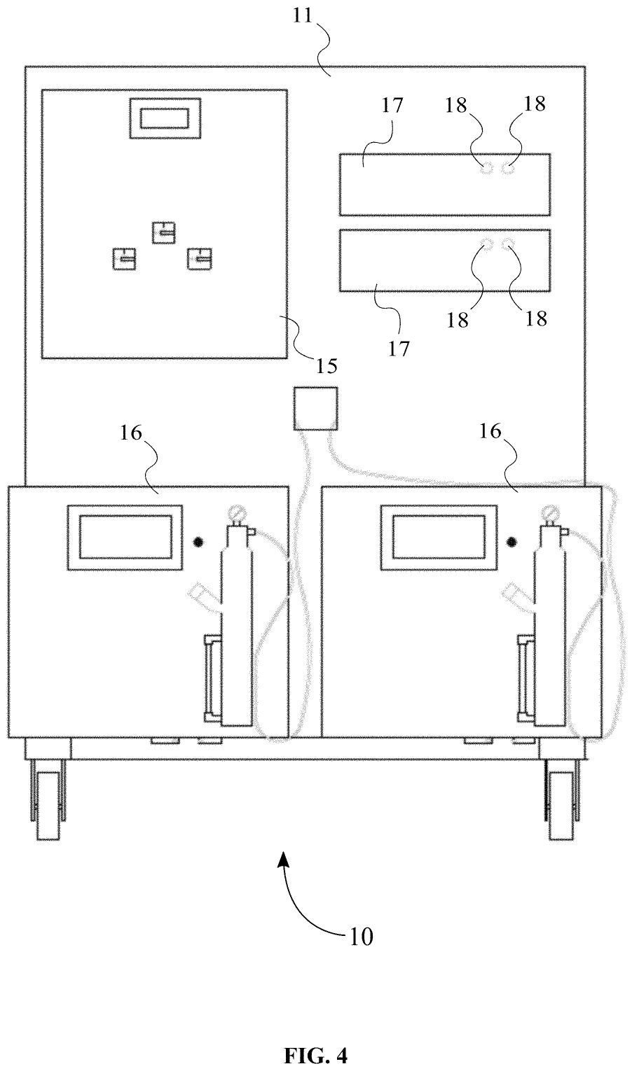

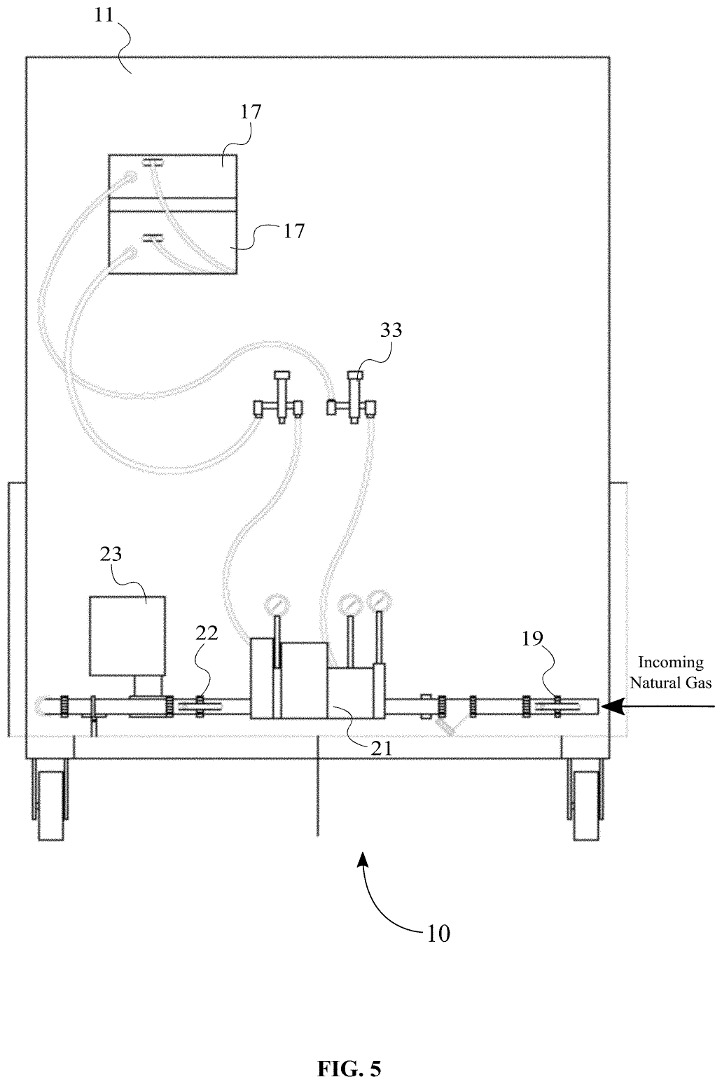

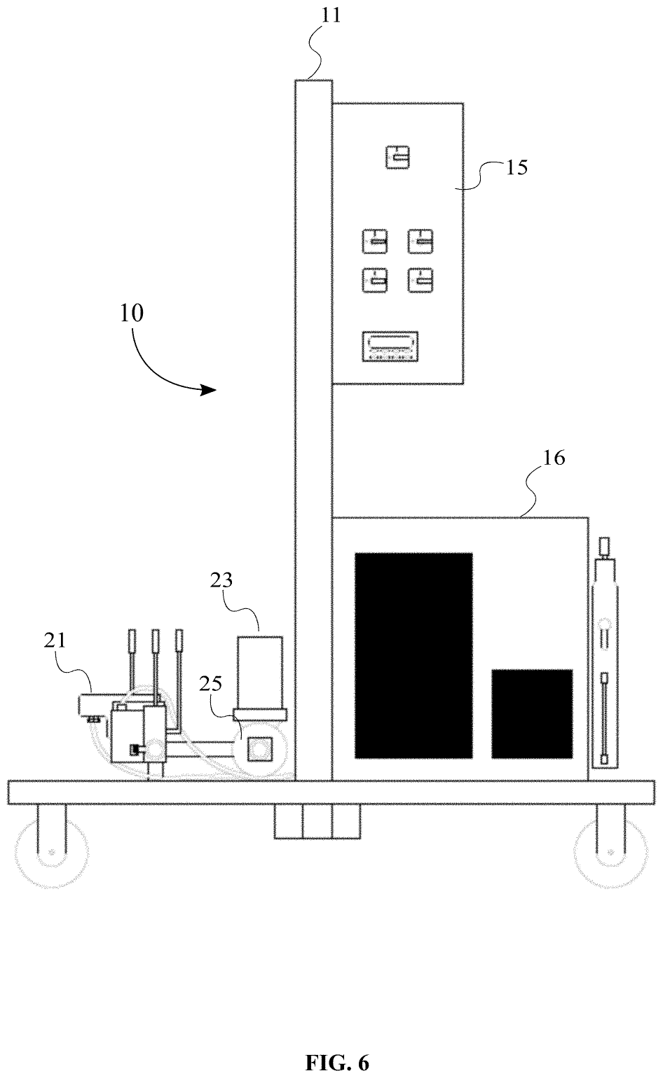

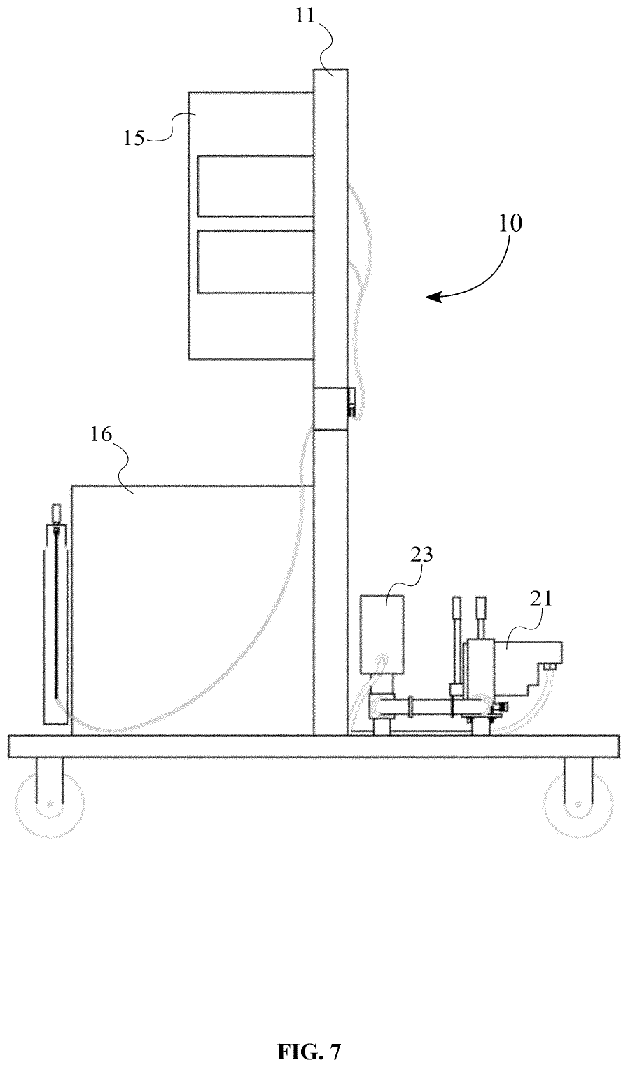

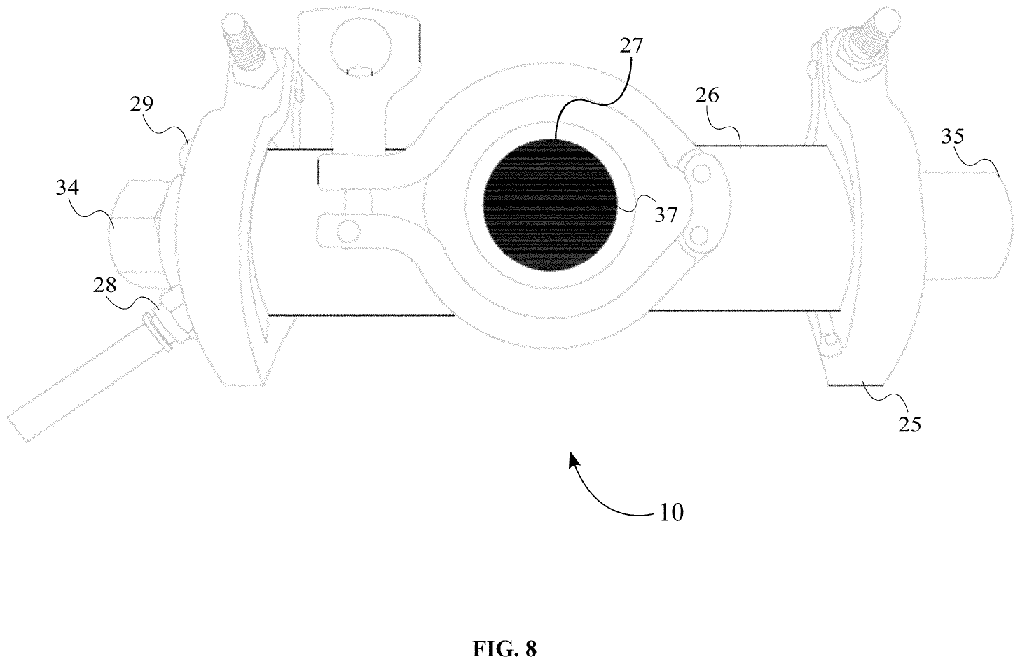

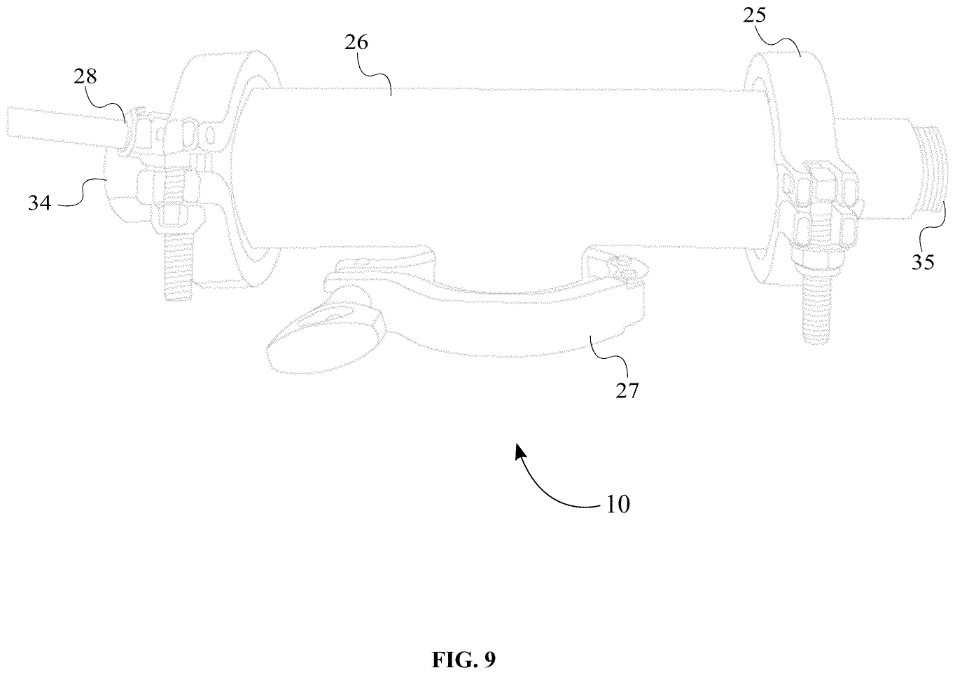

As can be seen in FIG. 1 to FIG. 10, the present invention provides an oxyhydrogen (HHO) burner system to eliminate emissions through total combustion. The HHO burner system of the present invention can be added to any exhaust system and/or exhaust stack to reduce emissions by passing the exhaust and/or gases through the flames and heat created by the present invention to create a total combustion environment. The HHO burner system works by adding one or more custom-made burners, which may have a substantial cross-section, to any stack, duct, or pipe, and delivering to the burner natural gas, propane, or any other fossil fuel gas and any type of water gas, such as HHO or Brown's gas, with or without compressed air, to create a total combustion of the exhaust before being released to the open environment. Thus, by passing all exhaust or gases through the present invention, emissions can be greatly reduced or even, in many cases, eliminated, including emissions of NOx, carbon, and sulfur dioxide.

As can be seen in FIG. 1 to FIG. 10, the present invention provides an HHO burner system to reduce and/or eliminate emissions through total combustion. The HHO burner system comprises a hydroburner system 10 and an exhaust system 50. The exhaust system 50 comprises an exhaust pipe 51, an inlet 52, an outlet 53, and an exhaust stream 54. The inlet 52 and outlet 53 are terminally and distally positioned on the exhaust pipe 51, opposite each other. The exhaust pipe can be the exhaust of an emissions stack and/or vent and may include, but is not limited to, metal pipe, duct, etc. Additionally, the exhaust stream 54 enters the exhaust pipe 51 through the inlet 52 and exits at the outlet 53. The hydroburner system 10 comprises a hydroburner 11, a gas pipe 12, and a burner assembly 13. More specifically, the hydroburner 11 comprises a controller 15, at least one oxyhydrogen (HHO) supply 16, an external natural gas supply 36, and a gas mixer 25. The at least one HHO supply 16 and the external natural gas supply 36 are connected to the gas mixer 25. The controller 15 is adapted to provide a predetermined mixing ratio of the HHO gas and natural gas to the gas mixer 25 for thorough mixing. The burner assembly 13 is connected to the gas mixer25 of the hydroburner 11 through the gas pipe 12. Additionally, the burner assembly 13 is positioned adjacent the exhaust pipe 51 of the exhaust system 50, between the inlet 52 and outlet 53. Further, the burner assembly 13 is adapted to distribute a flame onto a cross section of the interior of the exhaust pipe 51, thus providing total combustion to the exhaust stream 54 inside the exhaust pipe 51.

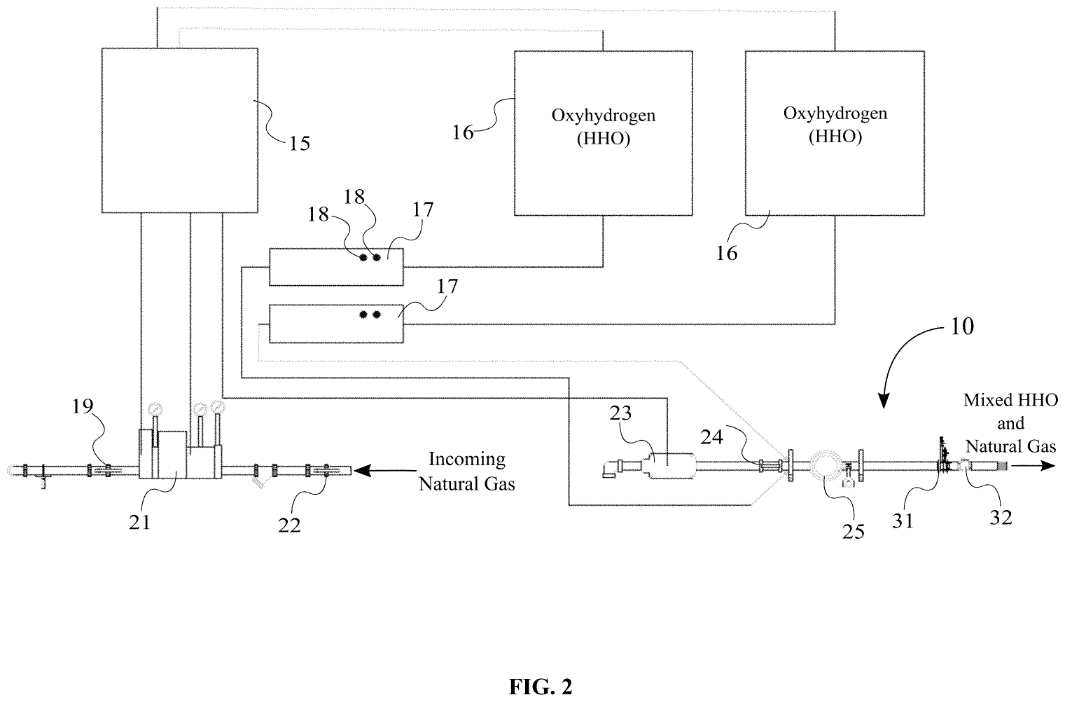

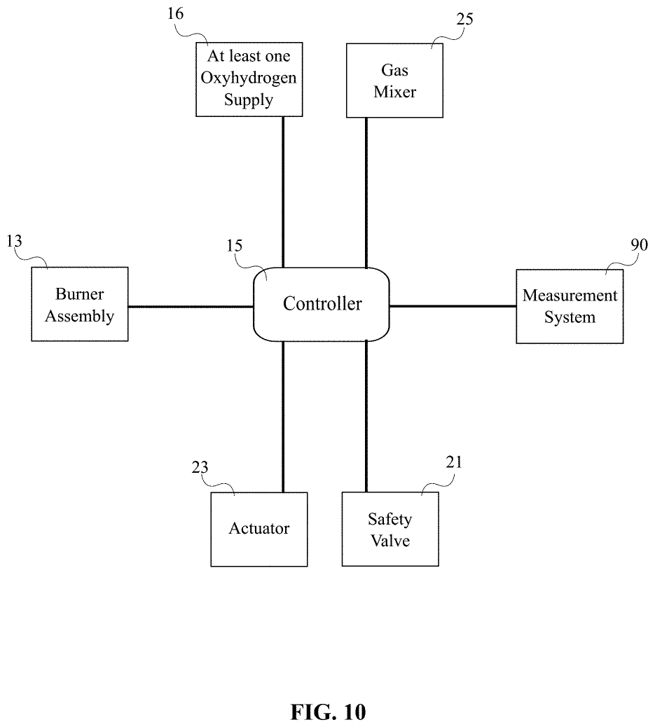

As can be seen in FIG. 2 to FIG. 7, and FIG. 10, the hydroburner 11 of the hydroburner system 10 comprises a check valve 22, a safety valve 21, an isolation valve 19, and an actuator 23. More specifically, the check valve 22 is connected to the external natural gas supply 36. Both the check va1ve22 and the isolation valve 19 are connected to the safety valve 21. Both the safety valve 21 and the actuator 23 are connected to the controller 15. Additionally, the actuator 23 is connected to the gas mixer 25. The connections in the hydroburner system 10 may include, but are not limited to, common gas pipes, tubes, joints, unions, and any other suitable piping parts. Further, the safety valve 21 of the hydroburner 10 comprises a pressure regulator, which is connected to the controller 15 to regulate the gas pressure of the hydroburner 10 below a predetermined safe operation pressure. Thus, the safety valve 21 is actuated by the controller 15 that monitors multiple functions to allow gas to flow safely through the system. Additionally, the controller 15 of the hydroburner 10 is adapted to regulate the pressure and flowrate of the incoming natural gas through the actuator 23. Further, the at least one HHO supply 16 of the hydroburner 10 is electrically connected to the controller 15. The controller 15 is adapted to regulate the pressure and flowrate of the HHO gas being delivered to the gas mixer 25.

As can be seen in FIG. 2 to FIG. 7, and FIG. 10, the at least one HHO supply 16 of the hydroburner 10 comprises a spark arrestor 17, which is electrically connected to the controller 15. The controller 15 is adapted to shut down the at least one HHO supply 16 through the spark arrestor 17 in case a flashback occurs to the at least one HHO supply 16. The spark arrestor 17 of the at least one HHO supply 16 comprises a bleeding valve 33 and a plurality of lights 16. Both the bleeding valve 33 and the plurality of lights 16 are electrically connected to the controller 15, which is adapted to relieve the pressure of the at least one HHO supply 16 through the bleeding valve in case a flashback occurs. Additionally, the controller 15 is adapted to display operating status of the at least one HHO supply 16 through the plurality of the lights 18.

As can be seen in FIG. 2 to FIG. 10, the gas mixer 25 of the hydroburner 10 comprises a mixing chamber 26, an implosion disk 27, a hole 37, a first inlet 28, a second inlet 29, a main inlet 34, and a mixed gas outlet 35. More specifically, the main inlet 34 is terminally and distally positioned on the mixing chamber 26. Both the first inlet 28 and the second inlet 29 are terminally positioned on the mixing chamber adjacent the main inlet 34. The mixed gas outlet 35 is terminally and distally positioned on the mixing chamber 26, opposite the main inlet 34. The hole 37 is laterally positioned on the mixing chamber 26, between the main inlet 34 and the mixed gas outlet 35. The implosion disk 27 is mounted within the hole 37 to rupture at a predetermined high pressure to relieve gas pressure of the mixing chamber 26. Additionally, the at least one HHO supply 16 is connected to the first inlet 28 or second inlet 29 of the gas mixer 25 through the spark arrestor 17. The actuator 23 is connected to the main inlet 35 of the gas mixer 25 so that the HHO gas from the actuator 23 is delivered to the mixing chamber 25 of the gas mixer 25 to be mixed with the natura gas. Further, the hydroburner 10 comprises a metering device 31 and a limiting valve 32. The limiting valve 32 is connected to the burner assembly through the gas pipe 12 while the metering device 31 is connected to the limited valve 32. Additionally, the metering device 31 is connected to the gas mixer 25 so that the mixed gas from the mixing chamber 26 can flow through the metering device 31 and the limiting valve 32 before being delivered to the burner assembly 13. The metering device 31 is electrically connected to the controller 15 and the controller 15 is adapted to provide a predetermined gas flowrate through the metering device 31.

As can be seen in FIG. 1 and FIG. 10, the HHO burner system of the present invention comprises a measurement system 10 that provides critical emissions measurements and input feedback to the controller 15 of the hydroburner system 10 to achieve the desired reduction and/or elimination of emissions contained in the exhaust stream 54 inside the exhaust pipe 51. More specifically, the measurement system 10 comprises an analytical instrument 91 and a plurality of sensors 92. The plurality of sensors 92 is electrically connected to the analytical instrument 91. Each of the plurality of sensors 92 is mounted on interior of the exhaust pipe 51 of the exhaust system 50, adjacent the outlet 53. The plurality of sensors 92 may include, but is not limited to, an electromechanical emissions sensor, a photoionization (PID) sensor, a nondispersive infrared (NDIR) sensor, and any other suitable sensors. Further, the measurement system 90 is electrically connected to the controller 15 of the hydroburner 10 of the hydroburner system 10 and the controller 15 is adapted to adjust to hydroburner 10 using the measurement system 90 to eliminate emissions in the exhaust stream 54 exiting the outlet 53 of the exhaust pipe 51 of the exhaust system 50. In alternative embodiments of the present invention, the HHO burner system may include, but is not limited to, a plurality of hydroburner systems 10. More specifically, the burner assembly 13 of each of the plurality of hydroburner systems 10 is connected to the exhaust pipe 51 of the exhaust system 50 through the gas pipe 12. Additionally, the burner assembly 13 of each of the plurality of hydroburner systems 10 is adapted to distribute a flame onto a cross section of the interior of the exhaust pipe 51, between the inlet 52 and outlet 53. Thus, multiple burner assemblies may be installed in the HHO burner system to provide cascade configuration to provide a series of HHO/natural gas flames to achieve complete elimination of emissions in the exhaust stream 54 through total combustion.

Although the invention has been explained in relation to its preferred embodiment, it is to be understood that many other possible modifications and variations can be made without departing from the spirit and scope of the invention as hereinafter claimed.

What is claimed is:

1. An Oxyhydrogen burner system for reducing and eliminating emissions through total combustion comprising:
a hydroburner system comprising:
a hydroburner comprising:
a gas mixer;
at least one oxyhydrogen (HHO) supply connected to the gas mixer;
a natural gas supply connected to the gas mixer; and
a controller adapted to provide a predetermined mixing ratio of the HHO gas and natural gas to the gas mixer;
a gas pipe; and
a burner assembly connected to the gas mixer through the gas pipe; and
an exhaust system comprising:
an exhaust pipe;
an inlet terminally positioned on a first end of the exhaust pipe; and
an outlet terminally positioned on a second and opposite end of the exhaust pipe;
wherein the burner assembly is positioned adjacent the exhaust pipe between the inlet and outlet, and further wherein the burner assembly is adapted to distribute a flame onto a cross section of an interior of the exhaust pipe.

2. The Oxyhydrogen burner system of claim 1, wherein the hydroburner further comprises:
a safety valve;
a check valve connected to the natural gas supply, connected to the safety valve, and connected to the controller;
an isolation valve connected to the safety valve and connected the controller; and
an actuator connected to the gas mixer.

3. The Oxyhydrogen burner system of claim 2, further wherein the safety valve comprises a pressure regulator, the pressure regulator connected to the controller to regulate the gas pressure of the hydroburner below a predetermined safe operation pressure.

4. The Oxyhydrogen burner system of claim 2, wherein the controller is adapted to regulate the pressure and flowrate of the incoming natural gas through the actuator.

5. The Oxyhydrogen burner system of claim 1, wherein:
the at least one HHO supply of the hydroburner is electrically connected to the controller; and
the controller is adapted to regulate the pressure and flowrate of the HHO gas delivered to the gas mixer.

6. The Oxyhydrogen burner system of claim 1, wherein:
the at least one HHO supply of the hydroburner comprises a spark arrestor, the spark arrestor is electrically connected to the controller; and
the controller is adapted to shut down the at least one HHO supply through the spark arrestor in case a flashback occurs.

7. The Oxyhydrogen burner system of claim 6, wherein:
the spark arrestor comprises a bleeding valve and a plurality of lights, where both the bleeding valve and the plurality of lights are electrically connected to the controller;
the controller is adapted to relieve the pressure of the at least one HHO supply through the bleeding valve in case a flashback occurs; and
the controller is adapted to display operating status of the at least one HHO supply through the plurality of the lights.

8. The Oxyhydrogen burner system of claim 1, wherein the gas mixer comprises:
a mixing chamber;
a main inlet terminally and distally positioned on the mixing chamber;
a first inlet terminally positioned on the mixing chamber adjacent the main inlet;
a second inlet terminally positioned on the mixing chamber adjacent the main inlet; and
a mixed gas outlet terminally and distally positioned on the mixing chamber, opposite the main inlet.

9. The Oxyhydrogen burner system of claim 8, wherein the gas mixer further comprises:
a hole laterally positioned on the mixing chamber, between the main inlet and the mixed gas outlet; and
an implosion disk mounted within the hole to rupture at a predetermined high pressure to relieve gas pressure of the mixing chamber.

10. The Oxyhydrogen burner system of claim 8, wherein:
the at least one HHO supply is connected to the first inlet or second inlet of the gas mixer through the spark arrestor; and
the actuator is connected to the main inlet of the gas mixer.

11. The Oxyhydrogen burner system of claim 1, wherein the hydroburner further comprises:
a limiting valve connected to the burner assembly through the gas pipe; and
a metering device connected to the limited valve, connected to the gas mixer, and electrically connected to the controller;
wherein, the controller is adapted to provide a predetermined gas flowrate through the metering device.

12. The Oxyhydrogen burner system of claim 1 further comprising a plurality of hydroburner systems, wherein the burner assembly of each of the plurality of hydroburner systems is connected to the exhaust pipe of the exhaust system and is adapted to distribute a flame onto a cross section of the interior of the exhaust pipe, between the inlet and outlet.

13. The Oxyhydrogen burner system of claim 1 further comprising:
a measurement system comprising:
an analytical instrument; and
a plurality of sensors electrically connected to the analytical instrument, where each of the plurality of sensors is mounted on the interior of the exhaust pipe adjacent the outlet.

14. The Oxyhydrogen burner of claim 13, wherein:
the measurement system is electrically connected to the controller; and
the controller is adapted to adjust to hydroburner using the measurement system to eliminate emissions exiting the outlet of the exhaust pipe of the exhaust system.

15. The Oxyhydrogen burner system of claim 13, wherein each of the plurality of sensors is a electromechanical emissions sensor.

16. The Oxyhydrogen burner system of claim 13, wherein each of the plurality of sensors is a photoionization (PID) sensor.

17. The Oxyhydrogen burner system of claim 13, wherein each of the plurality of sensors is a nondispersive infrared (NDIR) sensor.
